(19) United States
(12) Patent Application Publication
(10) Pub. No.: US 2023/0009002 A1
(43) Pub. Date: Jan. 12, 2023

(54) LOADING SYSTEM AND METHOD FOR LATERALLY LOADING AND UNLOADING AN UPPER BODY STRUCTURE ONTO AND FROM A VEHICLE PLATFORM OF A MOTOR VEHICLE

(71) Applicants: Hyundai Motor Company, Seoul (KR); Kia Corporation, Seoul (KR)

(72) Inventors: Bahman MOAREFI, Mainz (DE); Andrew VAUGHN, Mainz (DE); Vincent LAURENT, Frankfurt a Main (DE); Miroslav KROPAC, Mainz (DE); Jelle TJEBBES, Frankfurt am Main (DE); Sebastian KLÜH, Gimbsheim (DE); Ameya KARMARKAR, Russelsheim (DE); Rolf VERHOEVEN, Frankfurt am Main (DE); Kadir OGUZCAN GER, Mainz (DE)

(21) Appl. No.: 17/514,141

(22) Filed: Oct. 29, 2021

(30) Foreign Application Priority Data
Jul. 7, 2021 (DE) 10 2021 207 174.0

(51) Int. Cl. B60P 1/64; B60P 1/00

(52) U.S. Cl. CPC B60P 1/6436; B60P 1/006; B60P 1/649

(57) ABSTRACT

A loading system for laterally loading and unloading an upper body structure onto and from a vehicle platform includes loading gear rails mounted on respective lengthwise ends of the vehicle platform, the loading gear rails configured to jointly extend and retract from the vehicle platform by moving in a lateral direction of the vehicle platform, each loading gear rail having first gear teeth gear-engaging with a correspondingly formed platform gear wheel rotatably mounted on the vehicle platform and second gear teeth configured to engage a correspondingly formed upper body gear wheel at a respective lengthwise end of the upper body structure, wherein the platform gear wheel actuates lateral movement of the loading gear rails to engage the upper body structure with the loading gear rails at the upper body gear wheels and to load the engaged upper body structure onto the vehicle platform or to load and unload the engaged upper body structure from the vehicle platform.

### CROSS-REFERENCE TO RELATED APPLICATION

The present application claims priority to German Application No. 102021207174.0 filed on Jul. 7, 2021, the entire contents of which is incorporated herein for all purposes by this reference.

### BACKGROUND OF THE INVENTION

### Field of the Invention

The present invention pertains to a loading system and a method for laterally loading and unloading an upper body structure onto and from a vehicle platform of a motor vehicle. The present invention further pertains to a motor vehicle, in an electric motor vehicle, with such a loading system.

### Description of Related Art

Recently, some manufacturers of vehicles and automotive parts have put their focus on developing standardized and scalable electric vehicle (EV) platforms to underpin future vehicles in line with a completely new vehicle architecture to save development time and costs and thus get new electric cars on the road faster. To this end, modular electric-rolling and ready-to-drive platforms, a.k.a. “skateboards”, are designed to be mated with bodies of varies types and shapes. In this approach, the vehicle platform represents the part common to all vehicles and may combine chassis, powertrain, energy storage, crash management and so on. The upper body structure or “top hat” on the other hand comes in several variants specifically designed for different purposes according to the specific need of the customer.

Such purpose-built vehicles (PBV) may be designed for specific applications, like last-mile delivery or autonomous shuttles. They are designed from the start with specific applications in mind, and because of the standardization efforts up front, they may be produced at scale at a much lower price point than could otherwise be achieved. Purpose-built EV platforms may not only be lower in material cost but may also allow better performance in range, acceleration and internal space. Moreover, designing the vehicle architecture entirely around an EV concept, without combustion-engine legacy elements, means fewer compromises and more flexibility on average.

With the modular separation of the vehicle structure, a need arises to swap different body structures rapidly and smoothly on top of a vehicle platform. Various solutions are provided for this and similar purposes and include amongst others the MetroSnap concept by Rinspeed, the Vision URBANETIC approach by Daimler and Scania's NXT.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Hence, there is a need to find simple yet effective solutions for loading a vehicle platform with an upper body structure.

According to one aspect of the present invention, a loading system for laterally loading and unloading an upper body structure onto and from a vehicle platform of a motor vehicle includes at least two loading gear rails mounted on respective lengthwise end portions of the vehicle platform, the loading gear rails being configured to jointly extend and retract from the vehicle platform by moving in a lateral direction of the vehicle platform, each loading gear rail having a plurality of first gear teeth gear-engaging with a correspondingly formed platform gear wheel rotatably mounted on the vehicle platform and a plurality of second gear teeth gear-engaging with a correspondingly formed upper body gear wheel at a respective lengthwise end portion of the upper body structure, wherein the platform gear wheel is configured to actuate lateral movement of the loading gear rails to engage the upper body structure with the loading gear rails at the upper body gear wheels and to load the engaged upper body structure onto the vehicle platform or to load and unload the engaged upper body structure from the vehicle platform.

According to another aspect of the present invention, a motor vehicle, in particular an electric motor vehicle, has a loading system according to various exemplary embodiments of the present invention.

According to another aspect of the present invention, a loading station for loading and unloading an upper body structure onto and from a vehicle platform of a motor vehicle with a loading system according to the present invention includes a stationary loading ramp for laterally docking the vehicle platform configured to carry the upper body structure and having at least two counter guiding rails at respective lengthwise end portions disposed and configured to receive the laterally extending loading gear rails of the vehicle platform during the loading and unloading.

According to yet another aspect of the present invention, a method is provided for loading and unloading an upper body structure with a loading system onto and from a vehicle platform of a motor vehicle, in particular an electric motor vehicle. The loading system includes at least two loading gear rails mounted on respective lengthwise end portions of the vehicle platform, the loading gear rails being configured to jointly extend and retract from the vehicle platform by moving in a lateral direction of the vehicle platform, each loading gear rail having a plurality of first gear teeth gear-engaging with a correspondingly formed platform gear wheel rotatably mounted on the vehicle platform and a plurality of second gear teeth gear-engaging with a correspondingly formed upper body gear wheel at a respective lengthwise end portion of the upper body structure, wherein the platform gear wheel is configured to actuate lateral movement of the loading gear rails. The method includes engaging with and releasing, respectively, the upper body structure with the loading gear rails at the upper body gear wheels by extending and retracting, respectively, the loading gear rails; and loading and unloading, respectively, the engaged upper body structure on top of the vehicle platform by extending and retracting, respectively, the gear rails.

One idea of the present invention is directed to providing the vehicle platform itself with the means to load and unload the upper body structure rapidly and smoothly without the demand for complicated additional tools, components and/or devices. To the present end, the present invention realizes a swapping procedure based on a mechanism employing two extendable gear rails mounted on each lengthwise end portion of the vehicle platform, which engage with corresponding gear wheels on the upper body structure. The gear rails extend and retract laterally to load the upper body structure onto the vehicle platform and unload the upper body structure from it. During the present loading procedure, the upper body structure does not have to lifted or adjusted in height. Instead, the upper body structure may simply be moved horizontally from the vehicle platform to the loading ramp and vice versa.

Due to the present arrangement, the swapping system may be realized in a compact way with minimal space requirements, on the side of the vehicle platform, which therefore retains maximum flexibility with regards to installation space of other relevant equipment, e.g., of an electric battery. In the present way, PVB top hats, for example, may be exchanged rapidly and independently. Thus, the present invention solves one of the main challenges of PVB mobility concepts in an elegant way by facilitating loading and unloading within one integrated concept.

It is understood that the term “vehicle” or “vehicular” or other similar term as used herein is inclusive of motor vehicles in general such as passenger vehicles including sports utility vehicles (SUV), buses, trucks, various commercial vehicles, and the like, and includes hybrid vehicles, electric vehicles, plug-in hybrid electric vehicles, hydrogen-powered vehicles and other alternative fuel vehicles (e.g., fuels determined from resources other than petroleum). As referred to herein, a hybrid vehicle is a vehicle that has two or more sources of power, for example both gasoline-powered and electric-powered vehicles. Motor vehicles according to the present invention include manually driven vehicles as well as more or less autonomously and/or automatically driven vehicles.

Advantageous embodiments and improvements of the present invention are found in the subordinate claims.

According to various exemplary embodiments of the present invention, the vehicle platform may include a guiding rail at each respective lengthwise end portion, in which the respective loading gear rail is slidably engaged.

In the exemplary embodiment of the present invention, the guiding rails serve as bearing for the loading gear rails within the vehicle platform. For example, the guiding rails may be integrated in an upper side of the vehicle platform as appropriately formed grooves or the like that run from one lateral end portion of the vehicle platform to the other. Due the sliding arrangement, the gear rails may now simply be slid along the guiding rails from the vehicle platform to the loading ramp and into the counter guiding rails. Horizontal alignment of the guiding rails and the counter guiding rails then then ensures that the height of the top portion hat during swapping does not have to be adjusted in any way.

According to various exemplary embodiments of the present invention, each loading gear rail may include sliding wheels engaging with the respective guiding rail and configured to slide the respective loading gear rail along each respective guiding rail.

The sliding wheels ease movement of the gear rail along the guiding rails.

According to various exemplary embodiments of the present invention, the loading system further includes a control device configured to control the platform gear wheel to extend or retract the loading gear rails iteratively so that the upper body structure is loaded and unloaded onto and from the vehicle platform incrementally.

In this aspect of the present invention, the loading rails only need to extend from the vehicle platform far to reach the upper body gear wheels, which may be disposed close to a lateral side of the upper body structure. Hence, the loading rails may only be extended a fraction of a lateral width of the vehicle platform.

According to various exemplary embodiments of the present invention, the platform gear wheel may be driven by a powertrain of the vehicle platform.

Thus, no dedicated power source is required to actuate the loading gear rails and thus swap the upper body structure.

According to various exemplary embodiments of the present invention, the upper body structure may include a ratchet mechanism configured to selectively lock movement of the upper body gear wheels.

To the present end, each upper body gear wheel may be provided with a ratchet configured to block and unblock the respective wheel. In case the ratchets are blocked, the upper body structure may be pulled or pushed by the loading gear rails towards or from the vehicle platform. In case the ratchet mechanism is in unblocked configuration, movement of the loading rails will rotate the upper body gear wheels and the loading rails may be moved relative to the upper body structure, e.g., to release or engage it.

According to various exemplary embodiments of the present invention, the loading gear rails may be configured to move to first and second lateral sides of the vehicle platform.

Hence, loading and unloading is possible to first and second lateral sides of the vehicle platform. Thus, for example, one upper body structure may be removed from the vehicle platform to a first lateral side thereof. Next, another upper body structure may directly be loaded onto the vehicle platform from the second lateral side thereof.

According to various exemplary embodiments of the present invention, the upper body structure may include at least two upper body gear wheels at each respective lengthwise end respectively arranged on opposite laterals sides of the upper body structure.

For example, the upper body gear wheels may be arranged close to a lateral external edge portion of the upper body structure such that the loading rails to not necessarily need to extend very far from the vehicle platform to engage the gear wheels.

According to various exemplary embodiments of the present invention, the upper body structure may include sliding wheels at a lower side configured to engage with the vehicle platform and slide the upper body structure along an upper side of the vehicle platform.

Also in the instant case, the sliding wheels facilitate easy movement of the upper body structure relative to the vehicle platform (as well as the loading ramp).

The present invention will be explained in greater detail with reference to exemplary embodiments depicted in the drawings as appended.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 schematically depicts a modular motor vehicle having a vehicle platform that may be provided with a purpose-built upper body structure with a loading system according to various exemplary embodiments of the present invention.

FIG. 2 schematically shows a cross-sectional detailed side view of a loading gear rail used in the system of FIG. 1.

FIG. 3 schematically shows the system of FIG. 1 from the top together with a loading station according to various exemplary embodiments of the present invention.

FIG. 4 schematically shows the loading gear rail from FIG. 2 in a side view.

FIG. 5, FIG. 6, FIG. 7, FIG. 8, FIG. 9, FIG. 10 and FIG. 11 show consecutive steps of a loading process with the system of FIG. 1, FIG. 2, FIG. 3, and FIG. 4.

FIG. 12 shows a flow diagram of a method for using the loading system of FIG. 1, FIG. 2, FIG. 3, and FIG. 4.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and portion shapes will be determined in part by the particular intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

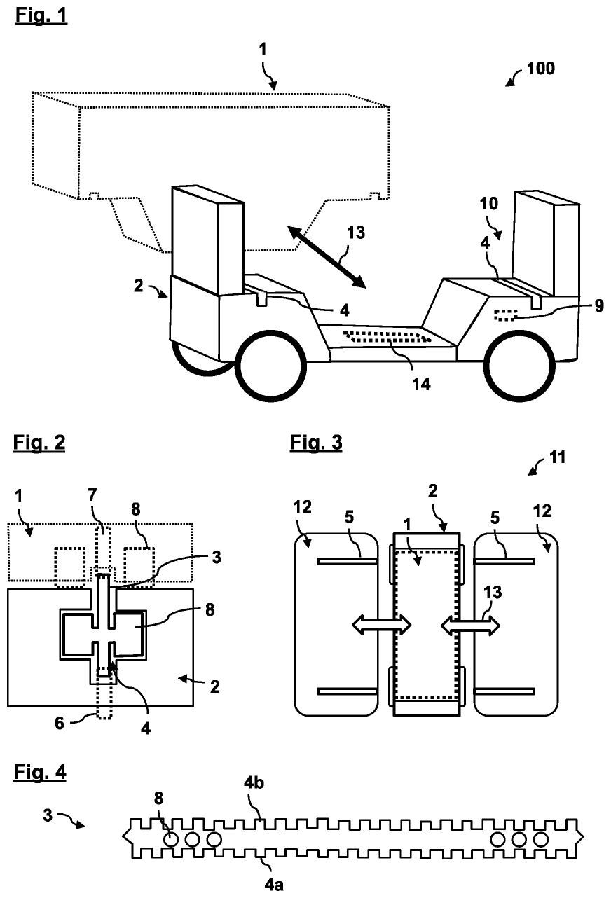

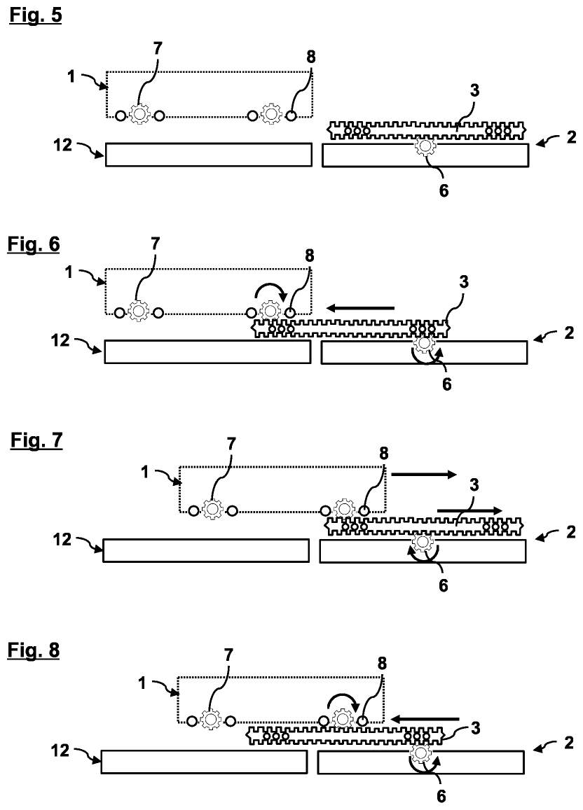

FIG. 1 schematically depicts a modular motor vehicle 100 having a vehicle platform 2 that may be provided with an upper body structure 1 in a lateral direction 13 of the vehicle 100. Loading and unloading of the upper body structure 1 is facilitated by a loading system 10, as will be described in the following. To the present end, the vehicle platform 2 parks inside a loading station 11 that has two stationary loading ramps 12 for laterally docking the vehicle platform 2 and configured to carry the upper body structure 1 before loading and after unloading. FIG. 3 shows the present arrangement from the top. FIGS. 2 and 4 schematically show a loading gear rail 4 used in the system 10 of FIG. 1 in cross-sectional and side views.

The motor vehicle 100 may be, for example, a purpose-built electric vehicle which is designed in a modular fashion based on two main parts, namely the vehicle platform 2 or skateboard and the upper body structure 1 or hat. The vehicle platform 2 represents the common substructure of the EV including chassis, powertrain, electric batteries and so on. The upper body structure 1 on the other hand may come in different variants fulfilling various purposes according to the customer's needs (e.g., cargo transportation like last-mile delivery or similar, passenger transportation like autonomous shuttle services, buses, taxis and so on).

In the exemplary embodiment of FIG. 1, the vehicle platform 2 is ‘U’-shaped, while the upper body structure 1 is complementary formed according to a V. It is to be understood that the shown shape and configuration is merely an example. Other shapes and configurations are of course possible, e.g., a flat vehicle platform 2 with a box-shaped upper body structure 1 on top of it.

The motor vehicle 100 may be, for example, autonomously and/or automatically driven and may be provided with various sensor systems as they are known in the art to monitor the environment and generate appropriate steering commands. Such sensors may also be utilized to monitor and steer the loading/unloading process of the motor vehicle 100. The motor vehicle 100, in particular the loading system 10, may be controlled by a control device 9, e.g., an electronic control unit (ECU). Electric power may be provided by an electric battery 14, which may be provided at a bottom area of the motor vehicle 100, as exemplarily depicted in FIG. 1.

The loading system 10 provides a simple and quick swapping concept that solves one of the main challenges for PBV, namely, how to load the upper body structure 1 onto the vehicle platform 2. As will be explained in the following, the present solution makes it possible to load and unload the upper body structure 1 in one swift procedure without having to lift heavy loads or adjust heights. Loading and unloading is possible in the instant case from both lateral sides of the vehicle platform 2 via the respective loading ramps 12. In this aspect of the present invention, it is possible to rapidly switch or swap one upper body structure 1 with another, e.g., by unloading a first upper body structure 1 to a first lateral side and by loading a second upper body structure 1 from a second lateral side thereof.

The loading system 10 includes two guiding rails 4 at respective lengthwise end portions of the vehicle platform 2, in which a respective loading gear rail 3 is slidably engaged (cf. FIG. 2). The loading gear rails 3 are configured to jointly extend and retract from the vehicle platform 2 by moving in the lateral direction with respect to the vehicle platform 2. When extended, the loading gear rails 3 enter corresponding counter guiding rails 5 on the loading ramps that are arranged at the same height and with the same orientation to align the loading station 11 with the vehicle platform 2.

Both loading gear rails 3 include several sliding wheels 8 on both sides along their longitudinal extension. The sliding wheels 8 are arranged in respective grooves of the corresponding guiding rail 4 and are configured to slide the respective loading gear rail 3 along each respective guiding rail 4 to ease relative movement of the loading gear rails 3 and the guiding rails 4. The upper body structure 1 has similar sliding wheels 8 to be able to easily roll across an upper side of the vehicle platform 2 and of the loading ramps 12 during loading and unloading.

Each loading gear rail 3 is provided with a plurality of first gear teeth 4a, which engage a correspondingly formed platform gear wheel 6 rotatably mounted on the vehicle platform 2. Each loading gear rail 3 is further provided with a plurality of second gear teeth 4b configured to engage correspondingly formed upper body gear wheels 7 at a respective lengthwise end portion of the upper body structure 1. The platform gear wheel 6 is driven by a powertrain of the vehicle platform 2 and actuates lateral movement of the loading gear rails 3, that is, extension and retraction, to engage the upper body structure 1 with the loading gear rails 3 at the upper body gear wheels 7 and to load and unload the engaged upper body structure 1 onto and from the vehicle platform 2.

The upper body structure 1 includes a ratchet mechanism configured to selectively lock movement of the upper body gear wheels 7 when engaged with the respective loading gear rail 3. Hence, in case that the ratchet mechanism is in a blocked configuration, any movement of the loading gear rails 3 will correspondingly move the upper body structure 1 when the second gear teeth 4b are engaged with the upper body gear wheels 7 of the upper body structure 1. Extending the loading gear rails 3 will push the upper body structure 1 laterally away from the vehicle platform 2. Correspondingly, a retraction of the loading gear rails 3 will pull the upper body structure 1 toward the vehicle platform 2. By switching to an unblocked configuration of the ratchet mechanism, any movement of the loading gear rail 3 will not drag the upper body structure 1 along anymore, which means that the loading gear rail 3 may be positioned relatively to the upper body structure 1. In the present unblocked configuration, the upper body structure 1 thus may be released either on top of one of the loading ramps 12 or on top of the vehicle platform 2.

A corresponding method M is shown in FIG. 12 as a flow diagram and includes under M1 engaging with and releasing, respectively, the upper body structure 1 with the loading gear rails 3 at the upper body gear wheels 7 by extending and retracting, respectively, the loading gear rails 3. The method M further includes under M2 loading and unloading, respectively, the engaged upper body structure 1 on top of the vehicle platform 2 by extending and retracting, respectively, the gear rails 3.

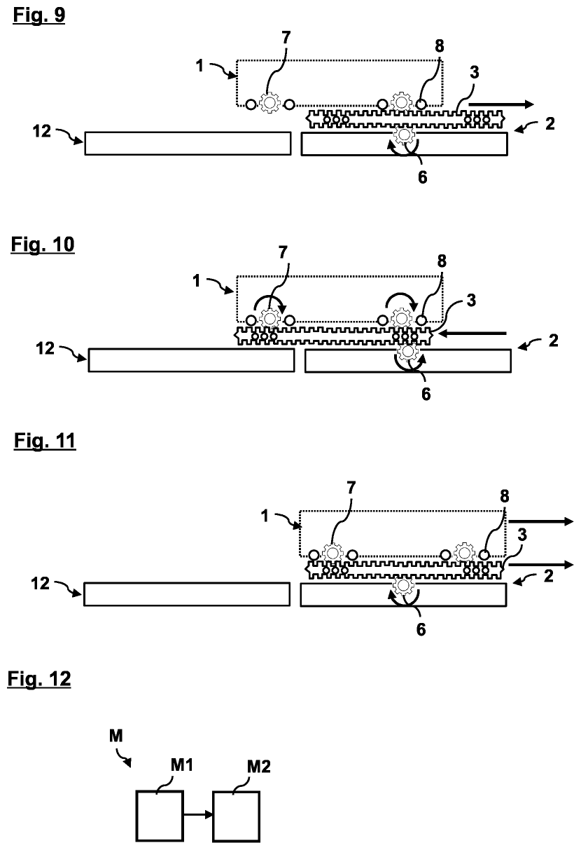

An exemplary loading process is described now with reference to FIGS. 5 to 11, which depict consecutive steps of a loading process with the system 10 of FIG. 1, FIG. 2, FIG. 3, and FIG. 4.

In FIG. 5, the upper body structure 1 rests on top of one of the loading ramps 12, e.g., the left loading ramp 12 in FIG. 3. By rotating the platform gear wheel 6 the loading gear rails 3 may be moved to the left, as shown in FIG. 6. The upper body gear wheels 7 are in unblocked configuration, which means that they also rotate as soon as the second gear teeth 4b are in engagement with them, facilitating movement of the loading gear rails 3 under the upper body structure 1.

Accordingly, the upper body gear wheels 7 are brought in locked configuration and the loading gear rails 3 are moved to the right (i.e., they are retracted back in to the vehicle platform 2), as shown in FIG. 7. To the present end, the platform gear wheel 6 is rotated in the opposite direction with respect to FIG. 6. The present procedure is repeated iteratively until the upper body structure 1 is mounted on top of the vehicle platform 2. The incremental movement of the upper body structure 1 may be controlled by the control device 9, which may trigger appropriate rotation of the platform gear wheel 6.

As illustrated in FIGS. 10 and 11, more than one upper body gear wheel 7 may be used for every loading gear rail 3. In the example of FIGS. 5 to 11, two upper body gear wheels 7 are arranged on opposite lateral edges of the upper body structure 1. It is to be understood of course that this is merely an example. The person of skill will readily conceive various other variants with two or more such gear wheels.

In addition, the term related to a control device such as “controller”, “control unit”, “control device” or “control module”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present invention. The control device according to exemplary embodiments of the present invention may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method disclosed in the aforementioned various exemplary embodiments of the present invention.

The aforementioned invention can also be embodied as computer readable codes on a computer readable recording medium. The computer readable recording medium is any data storage device that can store data which can be thereafter read by a computer system. Examples of the computer readable recording medium include hard disk drive (HDD), solid state disk (SSD), silicon disk drive (SDD), read-only memory (ROM), random-access memory (RAM), CD-ROMs, magnetic tapes, floppy discs, optical data storage devices, etc. and implementation as carrier waves (e.g., transmission over the Internet).

In an exemplary embodiment of the present invention, each operation described above may be performed by a control device, and the control device may be configured by multiple control devices, or an integrated single control device.

In an exemplary embodiment of the present invention, the control device may be implemented in a form of hardware or software, or may be implemented in a combination of hardware and software.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A loading system for laterally loading and unloading an upper body structure onto and from a vehicle platform of a vehicle, the loading system comprising:
at least two loading gear rails mounted on respective lengthwise end portions of the vehicle platform, the loading gear rails being configured to jointly extend and retract from the vehicle platform in moving in a lateral direction of the vehicle platform;
a platform gear wheel rotatably mounted on the vehicle platform; and
upper body gear wheels rotatably mounted at a respective lengthwise end portion of the upper body structure,
wherein each loading gear rail of the at least two loading gear rails has:
a plurality of first gear teeth gear-engaging with the platform gear wheel; and
a plurality of second gear teeth gear-engaging with at least one of the upper body gear wheels, and
wherein the platform gear wheel is configured to actuate lateral movement of the at least two loading gear rails to engage the upper body structure with the at least two loading gear rails at the upper body gear wheels and to load the engaged upper body structure onto the vehicle platform or to load and unload the engaged upper body structure from the vehicle platform.

2. The loading system of claim 1,
wherein the vehicle platform includes a guiding rail at each respective lengthwise end portion of the vehicle platform, and
wherein each loading gear rail of the at least two loading gear rails is configured to be slidably engaged in the guiding rail at each respective lengthwise end portion of the vehicle platform.

3. The loading system of claim 2, wherein each loading gear rail of the at least two loading gear rails includes first sliding wheels engaging with the respective guiding rail and configured to slide the respective loading gear rail along each respective guiding rail.

4. The loading system of the claim 1, further including a control device configured to control the platform gear wheel to extend and retract the at least two loading gear rails iteratively so that the upper body structure is loaded onto and unloaded from the vehicle platform incrementally.

5. The loading system of the claim 1, wherein the platform gear wheel is driven by a powertrain of the vehicle platform to actuate the lateral movement of the at least two loading gear rails.

6. The loading system of the claim 1, wherein the upper body structure includes a ratchet mechanism configured to selectively lock movement of the upper body gear wheels.

7. The loading system of the claim 1, wherein the at least two loading gear rails are configured to move to first and second lateral sides of the vehicle platform.

8. The loading system of the claim 1, wherein each of the upper body gear wheels at each respective lengthwise end portion is respectively arranged on opposite laterals sides of the upper body structure.

9. The loading system of the claim 1, wherein the upper body structure includes second sliding wheels rotatably mounted at a lower side of the upper body structure and configured to engage with the vehicle platform and slide the upper body structure along an upper side of the vehicle platform.

10. The loading system of the claim 1, wherein the vehicle platform is in a ‘U’ shape, and the upper body structure is in a shape complementary to the ‘U’ shape.

11. A vehicle including an electric motor vehicle, and having the loading system of the claim 1.

12. A loading station for loading and unloading the upper body structure onto and from the vehicle platform of the vehicle with the loading system of the claim 1, the loading station comprising:
a stationary loading ramp configured for laterally docking the vehicle platform configured to carry the upper body structure and having at least two counter guiding rails at respective lengthwise end portions disposed and configured for receiving the laterally extended loading gear rails of the vehicle platform during the loading and unloading.

13. A method for loading and unloading an upper body structure with a loading system onto and from a vehicle platform of a vehicle, the loading system including at least two loading gear rails mounted on respective lengthwise end portions of the vehicle platform, the at least two loading gear rails being configured to jointly extend or retract from the vehicle platform in moving in a lateral direction of the vehicle platform, each loading gear rail of the at least two loading gear rails having a plurality of first gear teeth gear-engaging with a platform gear wheel rotatably mounted on the vehicle platform and a plurality of second gear teeth gear-engaging with upper body gear wheels rotatably mounted at a respective lengthwise end portion of the upper body structure, wherein the platform gear wheel is configured to actuate lateral movement of the loading gear rails, the method including:
engaging the upper body structure with the at least two loading gear rails at the upper body gear wheels and releasing the upper body structure from the at least two loading gear rails, by extending and retracting, respectively, the loading gear rails; and
loading and unloading, respectively, the engaged upper body structure on top of the vehicle platform by extending and retracting, respectively, the loading gear rails.

14. The method of claim 13, wherein a control device is configured to control the platform gear wheel to extend and retract the at least two loading gear rails iteratively so that the upper body structure is loaded onto and unloaded from the vehicle platform incrementally.

15. The method of claim 13, wherein the platform gear wheel is driven by a powertrain of the vehicle platform.
